(19) United States
(12) Patent Application Publication
(10) Pub. No.: US 2005/0167035 A1
(43) Pub. Date: Aug. 4, 2005

(54) Dieless foiling

(76) Inventors: Paul Andrew Laskey, Cheshire (GB); Robert J. Goodfellow, Falkirk (GB); Trevor Hinchcliffe, Edinburgh (GB)

Correspondence Address: ROTHWELL, FIGG, ERNST & MANBECK, P.C., 1425 K STREET, N.W., SUITE 800, WASHINGTON, DC, 20005, US

(21) Appl. No.: 10/488,789

(22) PCT Filed: Aug. 16, 2002
(86) PCT No.: PCT/GB02/03793

(30) Foreign Application Priority Data
Sep. 5, 2001 (GB) 01214659
Apr. 9, 2002 (GB) 02081610

(51) Int. Cl. B32B 31/00; B44C 1/00

(52) U.S. Cl. 156/230; 156/233; 156/272.2

(57) ABSTRACT

A method for the application of a transferable layer from a foil (10) to a substrate (34). The method comprises the steps of applying an adhesive in a pattern to one of the substrate and the foil using a drop on demand deposition head (36); curing the adhesive; and transferring the transferable layer in the pattern from the foil to the substrate. There is also provided an apparatus for the application of a transferable layer from a foil to a substrate.

The present invention relates to methods and apparatus for the application of a transferable layer from a foil to a substrate.

In the printing industry, foils are used to enable the application of a metallic (or pigmented) layer to a substrate (i.e. a surface to be printed).

A foil is a laminated product comprising a metallic layer or a pigmented layer and an adhesive layer on the underside of the metallic or pigmented layer, which is carried on a plastics carrier layer, for example of polyester. Usually, a thin film of release agent is interposed between the plastics carrier layer and the metallic or pigmented layer to thereby facilitate separation of the metallic or pigmented layer from the carrier layer after adhesion of the metallic or pigmented layer to the substrate has taken place. There may also be other layers such as a lacquer layer or a holographic layer present.

Several techniques for the application of the metallic or pigmented layer to the substrate exist. One of the most common techniques for the application of the metallic or pigmented layer to the substrate is known as “dieless foiling”. This can take the form of either cold dieless foiling or hot dieless foiling.

In a known cold dieless foiling technique, adhesive is applied to the substrate using flexographic, lithographic or letter press techniques, so that the coverage of adhesive on the substrate corresponds to the metallic image desired to be transferred. This adhesive is applied as a wet formulation to the substrate, and is subsequently activated (rendered tacky) by one of several physical or chemical changes to the adhesive. The most common technique used to activate the adhesive involves irradiation with ultra-violet light which results in polymerisation of the adhesive components. An alternative method involves combinations of evaporation or oxidation of the applied adhesive, as described in U.S. Pat. No. 5,603,259. In the case of ultra-violet activation, the ultra-violet light initiates polymerisation of the monomer components in the adhesive.

In the time it takes the adhesive to pass through a tacky state and to cure, the substrate is passed through a foiling station in which a roll of foil is applied to the surface of the substrate and pressed against the adhesive. The distance between the UV drying station and the foiling station is critical in achieving adequate transfer and adhesion of the metallic or pigmented layer from the foil to the substrate. If the distance is too small, the adhesive will not be sufficiently tacky to adhere to the metallic layer of the foil. If the distance is too great, the adhesive will have completely cured and cannot be “reactivated”.

In addition, according to this technique it is not possible for components of the printing apparatus to impinge on the side of the substrate to which the adhesive has been applied between the UV drying station and the foiling station, since this would result in the adhesive being transferred to this component. For instance, it is not permissible for the path of the substrate to pass around a turner bar or rotating roller to redirect the pathway of the substrate towards the foiling station after the UV drying station.

The two above-mentioned problems have been overcome by the technique of hot dieless foiling, for example as described in the applicant's UK Patent No. 2338434. This involves the use of a different type of adhesive which can be reactivated after curing by application of heat. Thus the distance between the UV drying station and the foiling station is no longer critical because even if the adhesive has completely cured it can still be used to transfer the foil to the substrate upon application of heat. Since the adhesive can be completely cured prior to the foiling station, the problem of transfer to components of the printing apparatus is also negated, as it does not transfer when in a cured state. Therefore, components such as turner rollers can be used to direct the substrate as required. The foiling station usually comprises a pair of nip rollers forming a throughput nip, one of which is heated, so that the adhesive can be activated by the heat, thus simultaneously effecting transfer of the foil to the substrate.

Both the cold dieless foiling and hot dieless foiling techniques suffer from several problems. One problem is that the pattern in which the foil is transferred is by necessity the same as the pattern in which the adhesive is transferred. This in turn is dependent on the pattern used when applying the adhesive, for example on the flexographic plate. Thus it is only possible to foil in patterns which have been cut into the flexographic plate. This means that if a different pattern is required from the one currently being used, a different flexographic plate must be manufactured and fitted to the printing machine. It is also a somewhat inflexible system in that with any given machine set-up it is difficult to vary the pattern used. Furthermore the complexity and accuracy of the pattern used is limited by the physical nature of the flexographic plate.

The ability to vary the printed image is one of the great benefits of digital printing however, one of the main issues at present is the inability to print metallic inks due to their electrical conductivity interfering with the digital imaging/printing process.

Several methods have been proposed to print metallic effects using foil transfer technologies. The process typically uses a combination of heat and pressure to tackify a toner material and thereby transfer a metallic layer onto areas printed with the toner material. Examples are given in U.S. Pat. Nos. 4,724,026 and 4,868,049, assigned to Omnicrom Systems Ltd. Some drawbacks of this particular process are that the foil can adhere to all areas of thermoplastic printed toner, and the heat and pressure required can also make foiling onto thermoplastic or highly flexible materials difficult. An alternative method describing a low activation temperature foil adhesive for this process is given in WO 01/51290 in the name of Indigo N.V. The foil adhesive is again activated by heat and pressure but activates at a temperature below that of any other toner material and transfers only to certain areas.

It would be advantageous to provide a foiling system that allowed greater flexibility, accuracy and complexity in the pattern in which foil is transferred to the substrate and that is compatible with digital printing technologies.

Another problem that known hot and cold dieless techniques suffer from is that the position of the UV lamp within a printing machine is rather inflexible. This is because the step of UV curing the adhesive needs to occur at some distance before the transfer station so that the adhesive has either tackified sufficiently (in the case of cold dieless foiling) or cured sufficiently (in the case of hot dieless foiling) prior to transfer of the foil to the substrate.

It would also be advantageous to provide a foiling system that allowed greater flexibility in the positioning of the components.

According to one aspect of the present invention there is provided a method for the application of a transferable layer from a foil to a substrate, the method comprising the steps of:
(i) applying an adhesive in a pattern to one of the substrate and the foil using a drop on demand deposition head;
(ii) curing the adhesive; and
(iii) transferring the transferable layer in the pattern from the foil to the substrate.

The step of transferring the transferable layer to the substrate preferably comprises contacting the adhesive between the foil and the substrate.

In particular if the method is part of a cold dieless foiling method, it is preferred that steps (ii) and (iii) are conducted substantially simultaneously. Step (iii) can be effected by passing the substrate and foil through a throughput nip which effects the transfer of the transferable layer from the foil to the substrate.

In particular if the method is part of a hot dieless foiling method, it is usual for the method to comprise the further step (iv) of heating the one of the substrate and the foil bearing the cured adhesive to render the adhesive tacky. It is usual for steps (iii) and (iv) to be conducted substantially simultaneously. Conveniently step (iv) is effected by passing the substrate and foil through a heated throughput nip which effects heating of the adhesive to render the adhesive tacky and which effects the transfer of the transferable layer from the foil to the substrate. The heated throughput nip can comprises a heated roller and an impression roller through which the foil and substrate are fed at the same line speed with the foil layer to the side of the heated roller and the substrate to the side of the impression roller. Alternatively the heated throughput nip can comprise a heated platen and an impression bed. The impression roller or bed may or may not be heated. Advantageously the adhesive composition is such that, subsequent to curing of the adhesive, the adhesive can be rendered tacky by the application of heat to enable the subsequent transferring and adhering of the transferable layer from the foil to the substrate.

Regardless of whether the method is part of a hot or cold dieless foiling method, the drop on demand deposition head can be controlled to apply the adhesive in the pattern.

Conveniently in step (ii) the adhesive is cured to the extent that the cured adhesive is not transferred to any parts of an apparatus upon which the process is conducted that impinge on the pathway of the substrate between the curing step and the transfer step.

Whilst any means of curing the adhesive can be used, depending on the adhesive composition, including solvent or water evaporation, it is preferred that the curing step be effected by irradiation with ultra-violet light. If the curing step is effected by irradiation with ultra-violet light, advantageously the foil is at least partially UV transparent and the ultra-violet light is irradiated through the foil onto the adhesive. Alternatively, if the substrate is at least partially UV transparent the ultra-violet light can be irradiated onto the adhesive through the substrate.

Conveniently the pathway of the substrate is such that, subsequent to the curing step, and prior to the transferring step, the substrate is passed around a redirecting means (such as a turner bar or the like) that directs the pathway of the substrate towards a station in which the transferring step takes place.

Advantageously the method further comprises the step of applying one or more ink layers to the substrate prior to or after the application of the adhesive. This step can be carried out using a variety of techniques such as ink-jet printing or digital toner printing.

Usually such a method is continuous, allowing the transfer of many patterns of foil in sequence. Advantageously the drop on demand deposition head is controlled to print different patterns.

Usually the foil comprises a carrier layer, a release layer, and a transfer layer and the metallic or pigmented layer is transferred to the substrate by virtue of the ability of the applied adhesive to adhere to it being greater than the ability of the release layer to hold it to the carrier layer during step (iii).

The transferable layer can be a pigmented, metallic or holographic layer or more than one thereof, or may take another form. The term “foil” refers to a number of layers including a carrier layer bearing the one or more of these layers and possibly other layers. The release layer is suitably located between the carrier layer and the metallic or pigmented layer. Conveniently the adhesive is applied to the metallic or pigmented layer. The metallic layer may be pigmented. The foil may comprise a further adhesive layer, in which case the metallic layer is preferably located between the carrier layer and the further adhesive layer and the adhesive that is applied to the foil is preferably applied to the said adhesive layer.

Preferably the drop on demand deposition head is an ink-jet head.

According to another aspect of the present invention there is provided an apparatus for the application of a transferable layer from a foil to a substrate, the apparatus comprising:
(i) a drop on demand deposition head for applying an adhesive to one of the substrate and the foil in a pattern;
(ii) means for curing the adhesive; and
(iii) means for transferring the transferable layer in the pattern from the foil to the substrate.

According to another aspect of the present invention there is provided a method for the application of a transferable layer from a foil to a substrate, the method comprising the steps of: (i) applying an adhesive to one of the substrate and the foil; (ii) curing the adhesive by exposing it to a reaction catalyst through the one of the substrate and the foil; and (iii) transferring the transferable layer from the foil to the substrate.

According to yet another aspect of the present invention there is provided apparatus for the application of a transferable layer from a foil to a substrate, the apparatus comprising: (i) means for applying an adhesive to one of the substrate and the foil; (ii) means for curing the adhesive arranged to expose it to a reaction catalyst through the one of the substrate and the foil; and (iii) means for transferring the transferable layer from the foil to the substrate.

Suitably one of the substrate and the foil is at least partially UV transparent and step (ii) is carried out or means (ii) operates by irradiating ultra-violet light onto the adhesive through the one of the substrate and the foil.

The steps and means in the various aspects of the invention may be carried out or used in a number of orders. For example, step (ii) may be carried out before or after step (iii).

The curing may be total or partial curing. The step of curing the adhesive may consist of totally or partially curing the adhesive.

Embodiments of the present invention will now be described by way of example only with reference to the accompanying drawings in which:

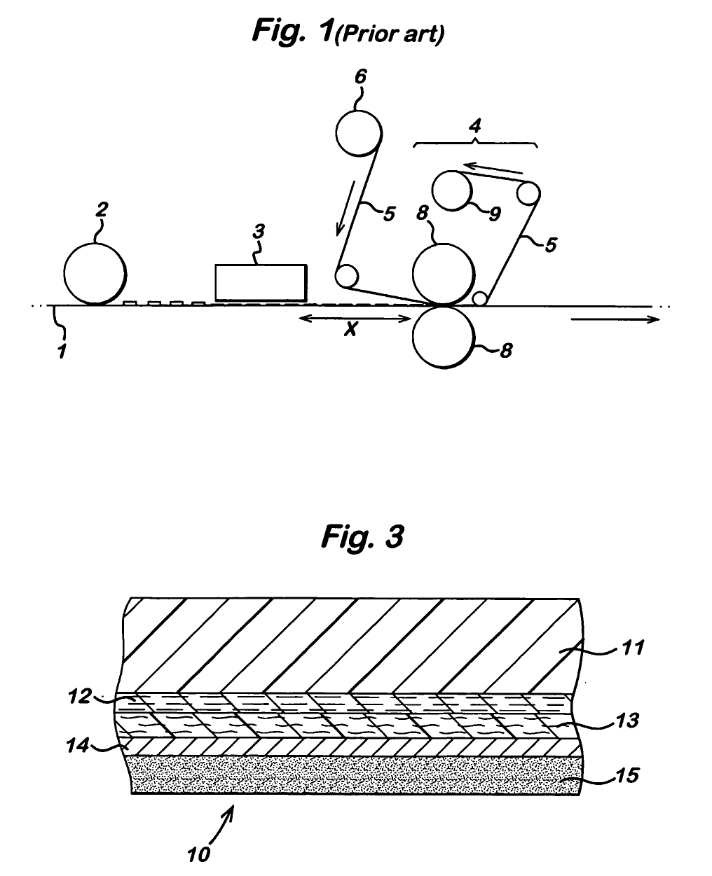

FIG. 1 schematically illustrates a cold foiling system of the prior art;

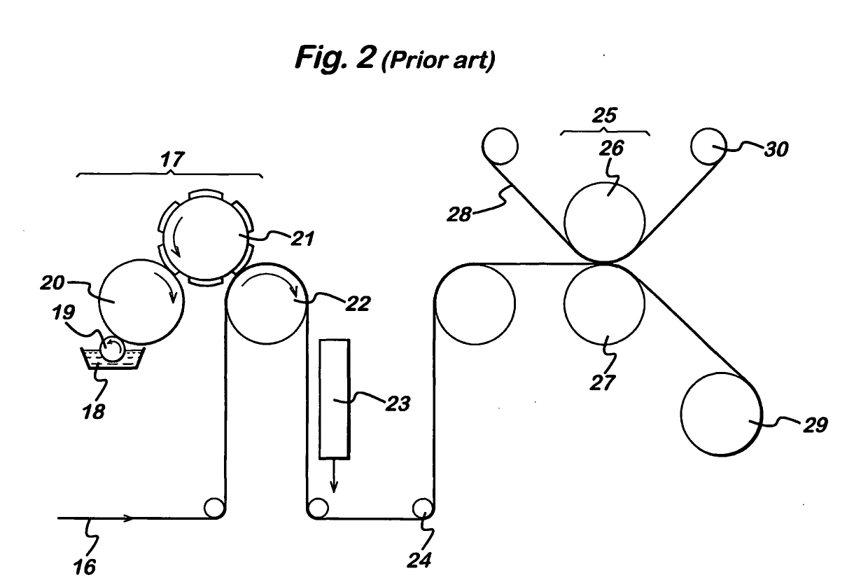

FIG. 2 schematically illustrates a hot foiling system of the prior art;

FIG. 3 illustrates a typical foil construction suitable for use in the apparatus and method of the present invention;

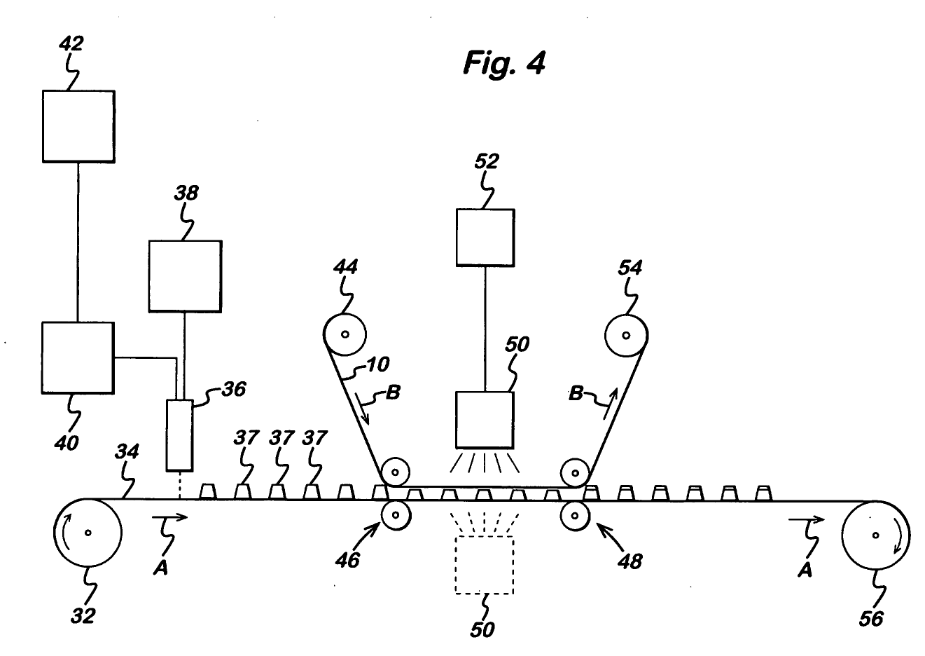

FIG. 4 schematically illustrates a cold foiling system of the present invention;

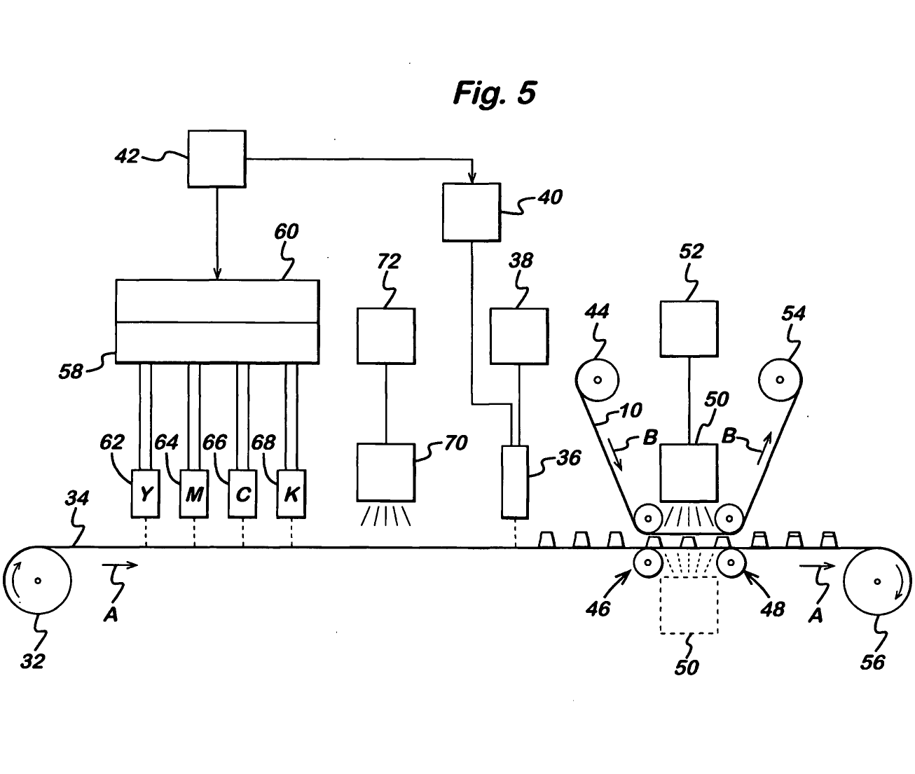

FIG. 5 schematically illustrates the system of FIG. 4 used with a colour ink-jet printing system;

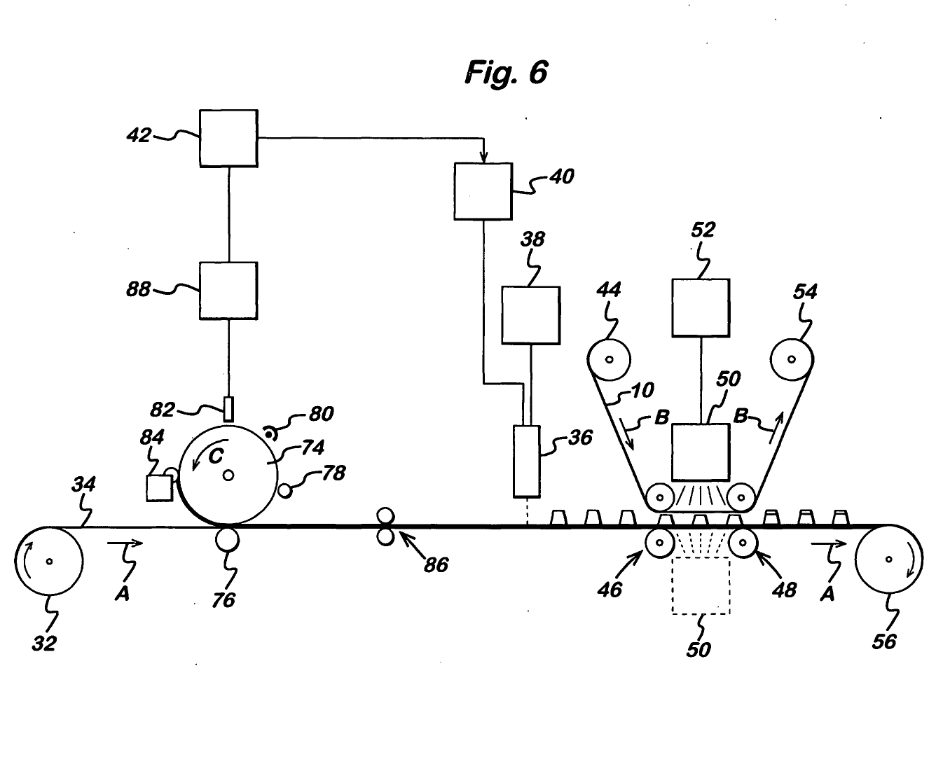

FIG. 6 schematically illustrates the system of FIG. 4 used with a digital ink printing system;

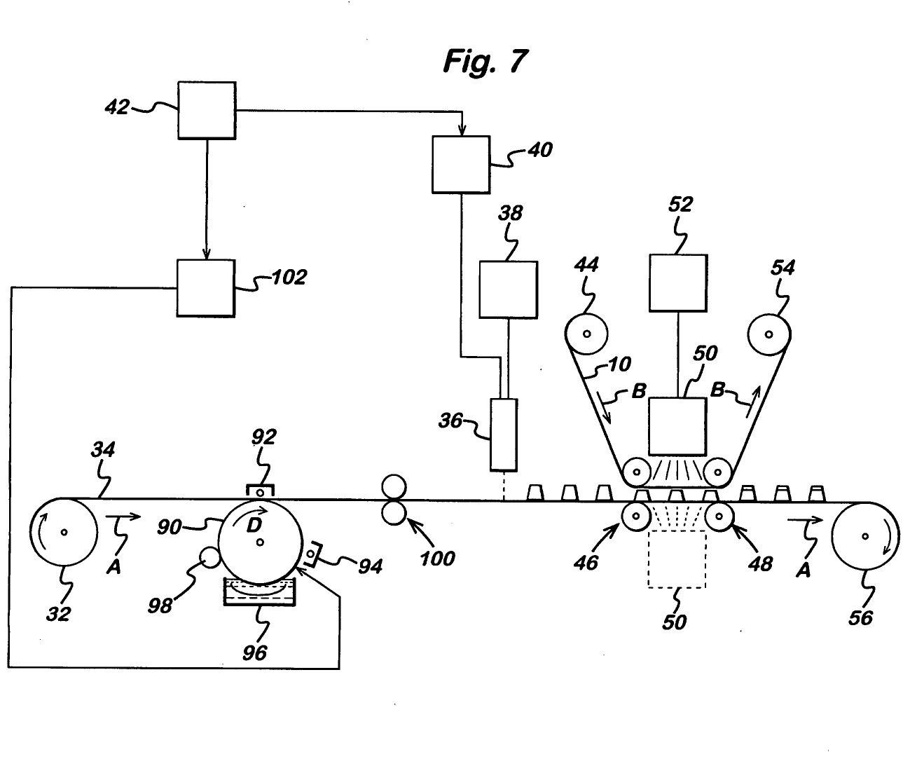

FIG. 7 schematically illustrates the system of FIG. 4 used with a liquid toner digital printing system;

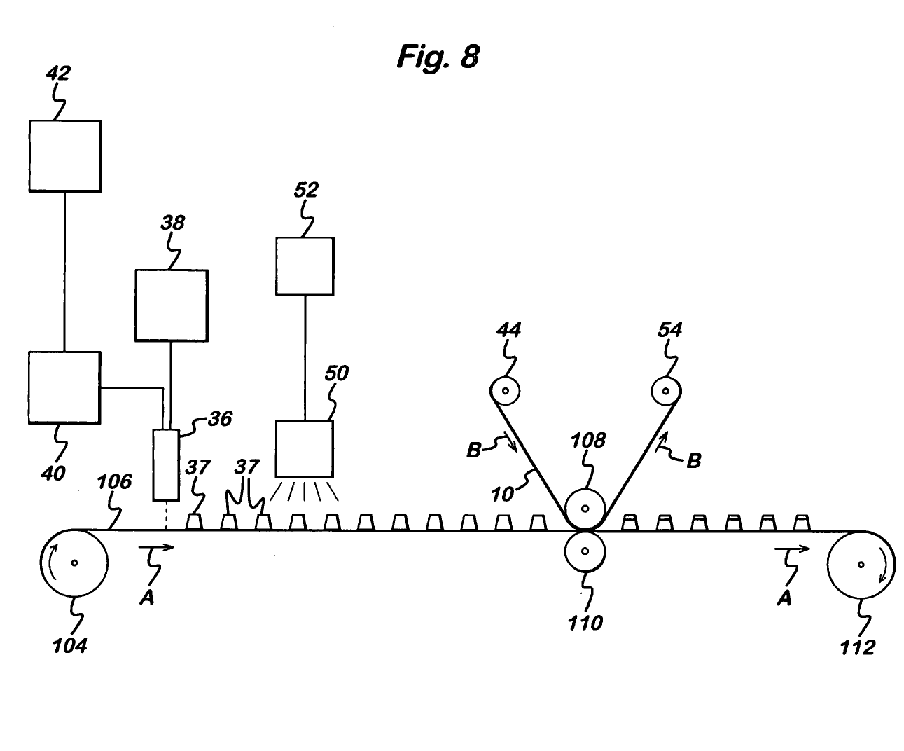

FIG. 8 schematically illustrates a hot foiling system of the present invention;

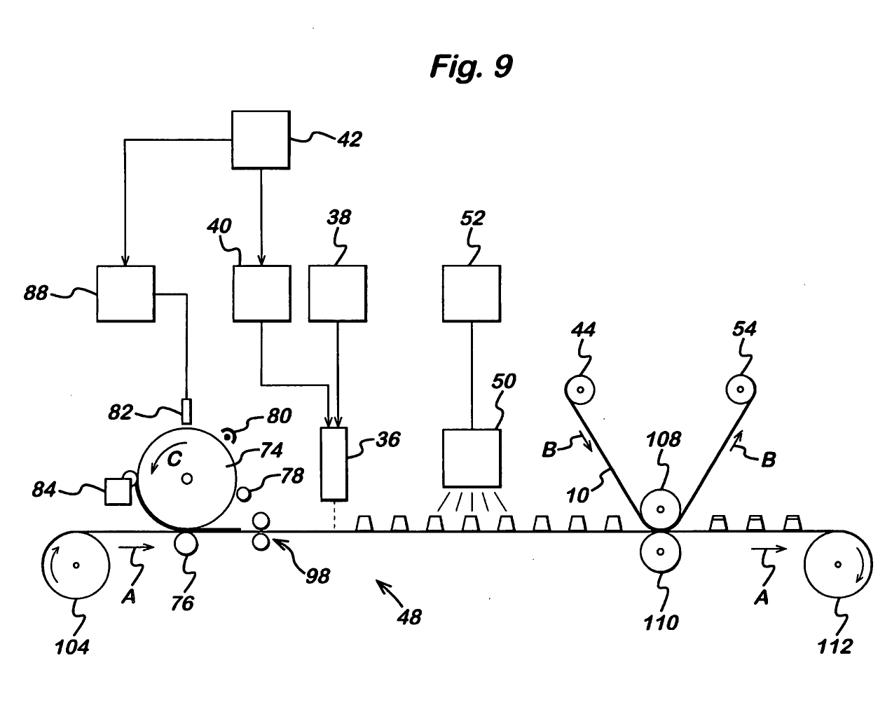

FIG. 9 schematically illustrates the system of FIG. 8 used with a digital ink printing system;

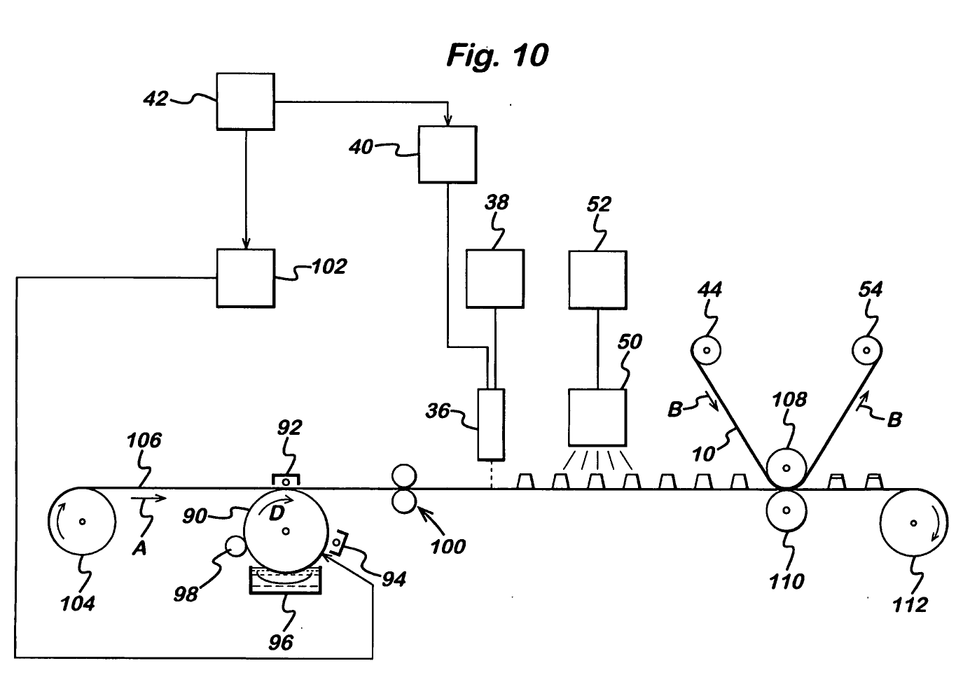

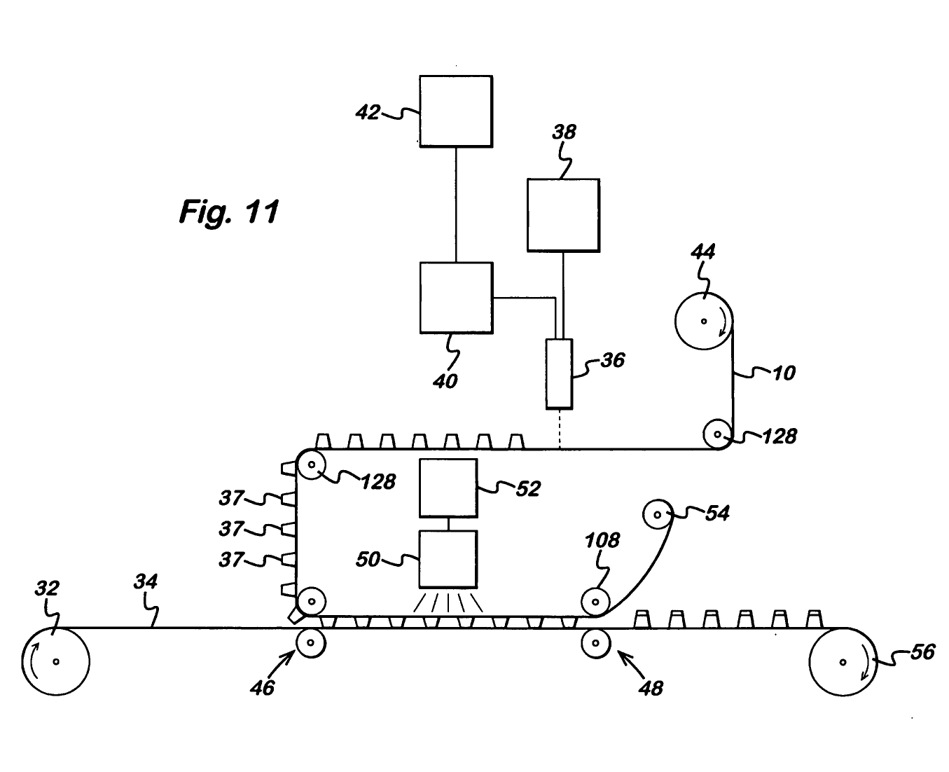

FIG. 10 schematically illustrates the system of FIG. 8 used with a liquid toner digital printing system;

FIG. 11 schematically illustrates a third embodiment using a cold foiling system;

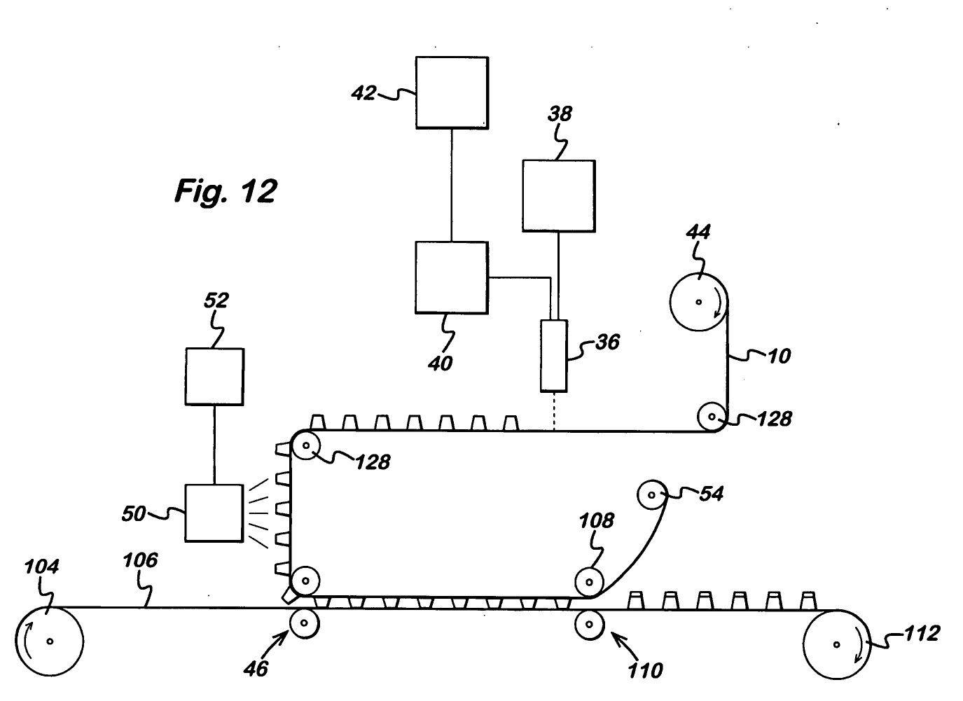

FIG. 12 schematically illustrates a fourth embodiment using a hot foiling system;

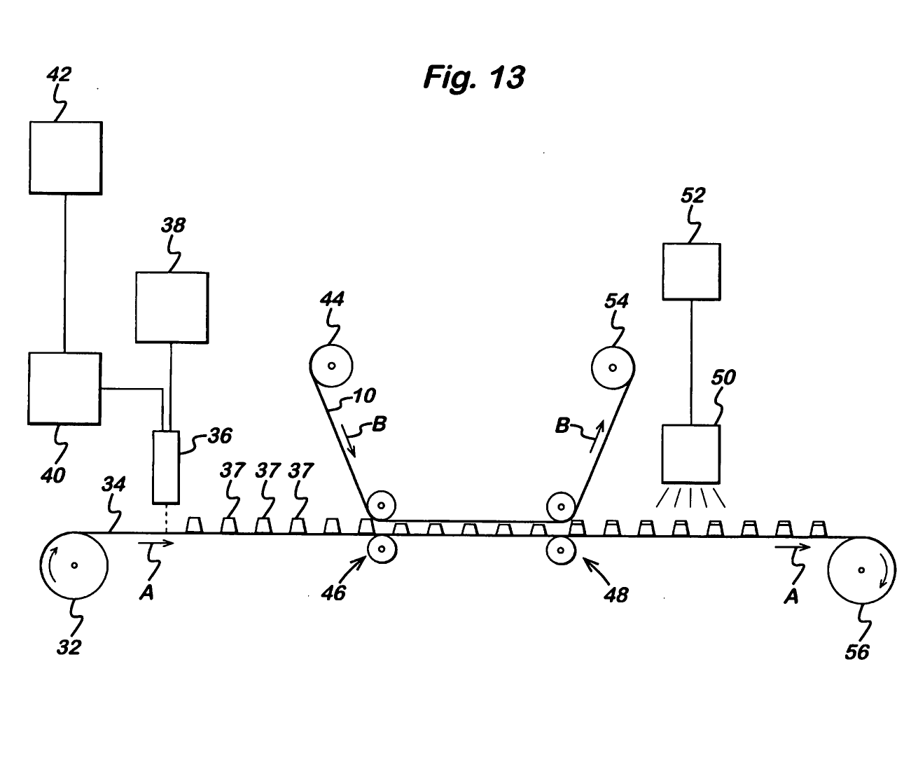

FIG. 13 schematically illustrates a fifth embodiment using a cold foiling system;

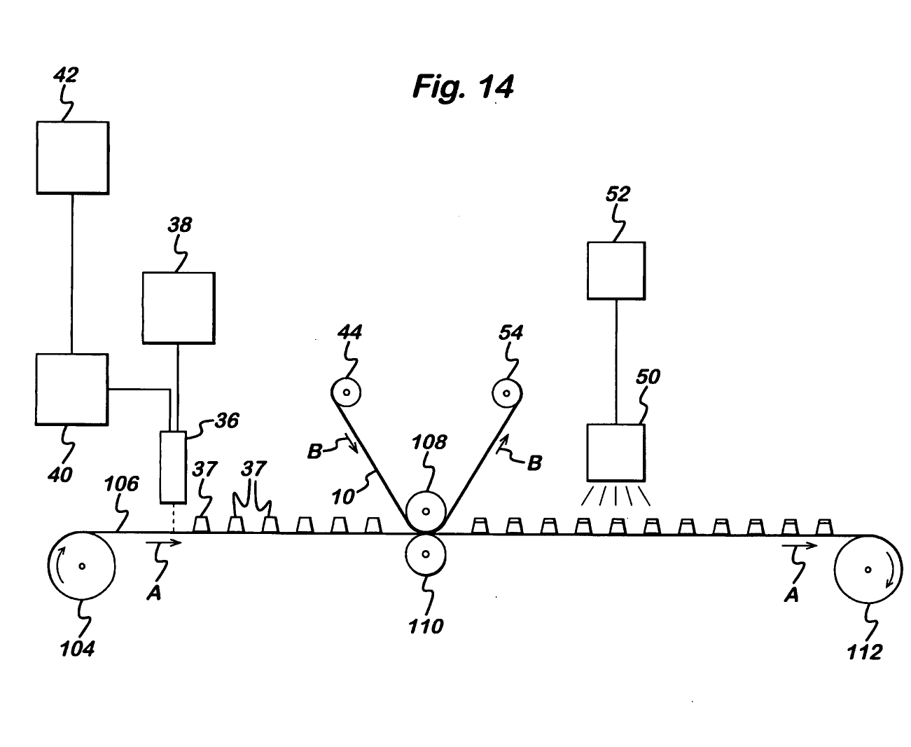

FIG. 14 schematically illustrates a sixth embodiment using a hot foiling system.

In the figures like reference numerals indicate like parts.

FIG. 1 illustrates an apparatus for cold foiling in accordance with the prior art. According to this technique, adhesive is applied to a substrate 1 at a printing station 2 by flexography. The substrate bearing the adhesive passes to a UV drying station 3 where the wet adhesive formulation is activated by the application of ultra-violet light. The ultra-violet light initiates polymerisation of the monomer components of the adhesive. In the time it takes the adhesive on the substrate to pass distance X illustrated in FIG. 1 to a foiling station 4, the adhesive has reached the desired state of tackiness to enable application of the metallic or pigmented layer of a foil 5 to the substrate 1. The foil 5 is unwound from a foil unwind spool 6 at the same line speed as the line speed of the substrate 1. The foil 5 passes, together with the substrate 1, through a laminating or throughput nip comprising two pressure rollers 8 where the metallic or pigmented layer of the foil 5 is removed from a carrier layer of the foil in a pattern corresponding to the areas of adhesive on the substrate 1. The spent foil is rewound onto spent foil rewind spool 9.

FIG. 2 illustrates an apparatus for hot foiling in accordance with the prior art. A substrate 16 in the form of a continuous web of paper, board or other heat resistant substrate, which has passed through a series of ink printing stations (not illustrated) is passed through an adhesive printing station 17. At the adhesive printing station 17, adhesive from tray 18 is picked up by an adhesive feed roller 19 and transferred to an anilox gravure roller 20. Adhesive from the anilox gravure roller 20 is supplied to the raised area on the cylindrical flexographic plate 21. The adhesive on the flexographic plate comes into contact with the substrate 16 which passes over a roller 22 which presses against the flexographic plate. The substrate 16 then passes to a station where there is provided means for curing the adhesive, in the form of an ultra-violet light source 23. The ultra-violet light source cures the adhesive on the substrate by initiating polymerisation of the polymerisable component. The substrate 16 then passes around a re-directing means in the form of a turner bar 24 and progresses towards a foiling station 25. The turner bar 24 can be omitted if it is not required to redirect the substrate.

The foiling station comprises means for heating the substrate bearing the cured adhesive to render the adhesive tacky, and means for transferring the pigmented or metallic layer from the foil to the adhesive-bearing areas of the substrate in the form of a heated laminating nip which comprises a heated roller 26 and an impression roller 27. The heated roller 26 is maintained at a temperature of between 140 to 200° C., and usually at a temperature of approximately 160° C. The impression roller is not heated.

The foil 28 and substrate 16 are fed through the laminating nip at the same line speed. This will usually be at least 40 metres per minute. With the substrate 16 and foil 28 moving at this speed through the laminating nip, and with the temperature of the heated roller at approximately 160° C., it has been found that the temperature of certain adhesives are raised to between 80 and 120° C. (usually approximately 100° C.) in order to render the adhesive tacky. The tacky, adhesive-bearing areas of the substrate will pull away the metallic or pigmented areas of the foil from the carrier layer of the foil. Spent foil is rewound onto the spent foil rewind spool 30, and the foiled substrate is wound onto the foiled substrate spool 29.

A typical foil construction 10 suitable for use in the present invention is illustrated in FIG. 3. The foil 10 comprises a polyester carrier layer 11 carrying a wax-based release layer 12. To the underside of the release layer 12 there is applied in sequence a lacquer layer 13, a metallic layer 14 and finally a layer of complementary adhesive 15. It will be understood by those skilled in the art that the structure of the foil can be varied, for example to have a pigmented layer. A lacquer layer may not be required or a holographic layer can be included as an extra layer. The complementary adhesive layer 15 is not present in all foils, however it is useful in certain uses of the foil, for example, if the foil is being applied to an ink layer, since it assists in adhesion of the foil.

Lacquer layer 13 may be designed so that it can be embossed to contain a holographic pattern. This can then be coated with metallic layer 14 as above or, where the underlying information needs to visible, metallic layer 14 can be replaced with a transparent material of a significantly different refractive index from that of the holographically embossed lacquer layer. Examples of refractive materials that can be used for this application are Zinc Sulphide, ZnS, Zirconium Dioxide, ZrO₂, Titanium Dioxide, TiO₂. These materials provide a high refractive index and are sufficiently transparent. Other materials of both higher and lower refractive index are known and any of these can be substituted.

Examples of highly reflective metals suitable for metal layer 14, are Aluminium (Al) and Silver (Ag). However, the deposition of other metals can lead to other effects, such as increased durability, lower cost or added conductivity.

The following describes application of a further adhesive layer and transfer of a metallic layer from the foil to a substrate by means of this layer. The technique is equally applicable to transfer of other transferable layers such as pigmented or holographic layers or more than one of any these. The technique could also be used to transfer transferable layers of other types. The transferable layer could be a composite layer comprising two or more sub layers of the same or different materials.

FIG. 4 shows a printing apparatus of an embodiment of the invention for performing cold dieless foiling. A substrate unwind spool 32 holds a supply of substrate 34 which is fed from the spool left to right in the figure, as indicated by arrows A. There is also provided an ink-jet head 36 supplied by an adhesive supply 38 and controlled by a microprocessor 40. A computer 42 is provided for programming the microprocessor 40. A foil unwind spool 44 holds a supply of the foil 10 shown in FIG. 3, which is also fed generally from left to right in the figure, as indicated by arrows B. There are also provided a first pair 46 of nip rollers and a second pair 48 of nip rollers. Disposed between the pairs 46, 48 of nip rollers is a UV lamp 50, controlled by lamp control system 52. Spent foil is collected on foil rewind spool 54 and foiled substrate is collected on foiled substrate spool 56.

In operation, substrate 34 is fed from substrate unwind spool 32 at a suitable line speed. It moves substantially horizontally as indicated in the figure. Ink-jet head 36 is disposed above the substrate and is controlled by microprocessor 40 to dispense adhesive in discrete quantities on the upper face of substrate 34 at intervals suitable for the line speed of the substrate 34 so that discrete adhesive patterns 37 are printed onto the substrate 34, at desired spacing. Ink-jet head 36 is controlled by microprocessor 40 which in turn is programmed by computer 42. By virtue of suitable computer software it can be controlled to print the adhesive in a variety of patterns of varying complexity.

This can be achieved by dot printing control techniques as known in the art that control the movement of the ink-jet head. For any given set-up of the printing machine, each discrete pattern 37 can be identical, or the pattern can be varied as desired by programming the microprocessor 40. It will be appreciated by those skilled in the art that computer 42 can be located near to or remote from the printing machine.

The term “pattern” is used to mean any formation in which it is desired to apply the adhesive. This could be anything ranging from a simple generally circular pattern to a complex pattern achieved by control of the ink-jet head 36. The pattern does not necessarily have to be in discrete areas but could be continuous.

The term “adhesive” is used as a general term to indicate the type of substance being printed by ink-jet head 36. The exact composition can vary in dependence on, for example, the intended use of the foiled substrate 34, the material of the substrate 34 and whether it is desired to transfer pigment, foil or a combination of both. As will be appreciated after reading the further description below, the adhesive needs to contain a substance which reacts to UV light or another reaction catalyst, such as evaporation or oxidation, and can consequently act as an adhesive. In this embodiment it contains monomer components that are polymerised upon exposure to UV light. The adhesive also needs to be suitable for spraying by ink-jet head 36, for example in its consistency and in that it should not clog up the ink-jet head. The adhesive may contain other substances such as ink. One suitable adhesive is the “Crystal” range of UV curing inks manufactured by Sunjet and available in 9 colours and a UV curable clear. These particular inks are suitable for use with ink-jet heads manufactured by XAAR Ltd. and Spectra Inc.

Two suitable types of ink-jet head are the XJ500/180/UV and the XJ500/360/UV available from XAAR Ltd., Cambridge, UK. Another suitable one is the Nova JA-256/80 LQ available from Spectra Inc., New Hampshire, USA. Ink-jet head 36 could be replaced with any suitable drop on demand deposition head and associated apparatus.

Substrate 34 with discrete adhesive patterns 37 thereon is fed to the first pair 46 of nip rollers. Foil 10 is fed from foil unwind spool 42 at the same line speed assubstrate 34, also to the first pair 46 of nip rollers. Thus both substrate 34 and foil 10 pass in overlap through the first pair 46 of nip rollers. These rollers form a throughput nip in which substrate 34 and foil 10 are compressed together. The compressed foil and substrate are fed onwards in overlap so that they pass underneath UV lamp 50.

As can be seen in FIG. 4, UV lamp 50 irradiates UV light onto foil 10. UV lamp control system 52 controls the intensity of the lamp and the time of activation, although it may be more convenient for UV lamp 50 to be on continuously during operation of the printing machine. Foil 10 is partially transparent to UV light so that the UV light passes through it to the adhesive patterns 37 and activates the adhesive to polymerise its monomer components. In this embodiment the thickness of the metal layer corresponds to a resistivity of 2-4 Ohms/m². The thickness typically corresponds to between 0.01 Ohms/m² and 10 Ohms/m² but can be varied in dependence upon line speed, optical reflectivity/foil brightness, lamp power and the activatable component of the adhesive.

The foil, substrate and activated adhesive then pass through the throughput nip formed by second pair 48 of nip rollers. Since the adhesive is in an activated state and under pressure from the throughput nip, and the ability of the adhesive to adhere to complementary adhesive layer 15 is greater than the ability of the release layer 12 to hold layers 13, 14, 15 of the foil to carrier 11, an area of lacquer layer 13, metallic layer 14 and complementary adhesive layer 15 from foil 10 corresponding to each discrete adhesive pattern 37 is removed from carrier layer 11 and sticks to the adhesive and is thus transferred onto the substrate 34. Upon transfer the adhesive has cured sufficiently to allow the foil to stick or adhere to substrate 34.

The foiled substrate 34 bearing the discrete patterns of foil continues beyond the second pair 48 of nip rollers and is wound onto foiled substrate spool 56. The spent foil 10 is wound onto foil rewind spool 54. This comprises carrier layer 11 and any parts of the other layers of foil 10 that have not been transferred to substrate 34.

Thus it can be understood that the pattern of adhesive applied to substrate 34 by ink-jet head 36 determines the pattern in which foil is transferred to substrate 34. This means that there is no need for a fixed image plate such as a flexographic plate and therefore that the digital nature of the computer control of the ink-jet head allows the adhesive and hence the foil to be applied in a variety of patterns. Furthermore, the non-contact nature of the adhesive application procedure and the fact that in this embodiment it can occur at ambient temperature allows printing on very delicate, highly flexible or heat sensitive substrates. The type of adhesive used in the embodiment does not become excessively tacky and hence is suitable for use with delicate substrates.

The ink-jet head can be controlled to generate a repeated periodic pattern on the substrate. Alternatively, the ink-jet head can generate periodic differing patterns. The latter arrangement is especially useful for forming security features on the substrate, for example for tickets or bank notes. Serial numbers, bar codes or in general unique identifiers could be defined on the substrate by the pattern of the adhesive.

It can also be seen that this embodiment allows activation of the adhesive to occur by passing UV light through the foil 10. This means that the distance between the UV light 50 and the foil transfer location (nip rollers 48) is not particularly critical since, due to the line speed of the foil 10 and substrate 34, transfer occurs substantially immediately after the adhesive is activated. This means that the precise location of the components of the printing machine is not critical. Furthermore this method can result in a higher gloss in the foil than some prior art methods due to the liquid adhesive forming a very smooth surface when in contact with the foil prior to curing.

FIG. 4 shows in dotted formation an alternative position for UV lamp 50 below substrate 34. This position may be more convenient and is suitable if substrate 37 is at least partially transparent to UV light.

FIG. 5 shows the arrangement of FIG. 4 used together with an ink-jet printing system. In addition to the components of FIG. 4 there is provided an ink-jet supply system 58 controlled by ink-jet microprocessor 60. Ink-jet supply system 58 feeds four ink-jet heads, a yellow ink-jet head 62, a magenta ink-jet head 64, a cyan ink-jet head 66 and a black ink-jet head 68. Computer 42 is used to program microprocessor 60 in addition to microprocessor 42. There is also provided a second UV lamp 70 with a lamp control system 72.

In operation, substrate 34 is fed from substrate unwind spool 32 but before arriving at ink-jet head 36 it passes underneath ink-jet supply system 58. The four ink-jet heads 62, 64, 66 and 68 are controlled to print an image on substrate 34, either in just black (using black ink-jet head 68) or in multicolour using all four ink-jet heads 62, 64, 66 and 68. The ink-jet supply system can be controlled to print an image on discrete areas of the substrate 34 corresponding to the areas on which adhesive is to be applied. This may be desirable if the substrate is transparent and hence the printed image will be visible through it. Alternatively it can be controlled to print on other areas of the substrate as well. For example, it may be desired to print some words on the substrate in areas not intended to be foiled so that the words are visible around the foil.

In this embodiment the ink used in ink-jet supply system 58 is free radical cure ink. Therefore, following printing of the image, the substrate 34 passes underneath the second UV lamp 70. UV lamp 70 is controlled by control system 72 to irradiate UV light onto the printed image, thus curing the ink. Components 70 and 72 can be dispensed with if the printed ink cures by some other means such as evaporation or oxidation.

Following printing of the image on substrate 34, it continues on to have the foil applied in the manner described with reference to FIG. 4.

FIG. 6 shows the arrangement of FIG. 4 used together with a digital printing system. In addition to the components of FIG. 4, there are provided a printing roller 74 arranged to form a throughput nip with a transfer corona 76. Disposed around printing roller 74 are a cleaning station 78, a charging station 80, an imaging station 82 and a toner station 84. Downstream (in the direction of movement of substrate 34) of printing roller 74 is a fusing station 86. The digital printing system is controlled by a printing microprocessor 88 that is programmed by computer 42. These components are a schematic representation of a dry toner digital printer such as those manufactured by AGFA or XEIKON. One such printer is the AGFA Chromapress 32Si.

In operation, printing roller 74 is arranged to rotate in the direction of arrow C so that its outer surface continuously passes through the surrounding stations 78, 80, 82, 84. At charging station 78 the outer surface of roller 74 is charged. The charged surface then passes beneath imaging station 80 which is controlled by microprocessor 88 to discharge the areas where it is not required to print an image. The surface then passes onto toner station 82, wherein toner is applied on the charged areas of the surface in the desired image to be printed on the substrate. The image can be black or multi-colour. The surface bearing the toner then rotates to transfer corona 76. Substrate 34 is fed from unwind spool 32 through the throughput nip formed between printing roller 74 and transfer corona 76, wherein the toner is transferred to substrate 34. Thus the image desired to be printed has been transferred to substrate 34.

Having transferred the image to substrate 34, the surface of printing roller 74 passes through cleaning station 78 wherein any toner residue is removed ready for the surface to be used again.

Following transfer of the image, printed substrate 34 continues through a further throughput nip formed by two rollers of fusing station 86. At least one of these rollers, usually the one that comes into direct contact with the printed image (the upper roller in the figure), is heated so as to cause fusing of the image onto substrate 34 so that it is permanently bonded to the substrate, thus preventing the image from being damaged. It may be appropriate to use a primer prior to printing of the image to prevent damage during subsequent application of the heat when applying the foil. The printed substrate 34 then passes on to have the foil applied in the manner described with reference to FIG. 4. Due to the use of a cold foiling process, reactivation of toner is avoided.

FIG. 7 shows the arrangement of FIG. 4 used together with a liquid toner digital printing system. In addition to the components of FIG. 4, there are provided an OPC drum 90 arranged with a transfer corona 92. Disposed around OPC drum 90 are a charging corona 94, a toner trough 96 and a reverse doctor roll 98. Downstream (in the direction of movement of substrate 34) of OPC drum 90 is a fuser 100. The liquid toner digital printing system is controlled by a microprocessor 102 which is programmed by computer 42. These components are a schematic representation of a printing system such as an Indigo Omnius Webstream series digital printer.

In operation, OPC drum 90 is arranged to rotate in the direction of arrow D so that its outer surface continuously passes through the surrounding components 94, 96, 98. At charging corona 94 the outer surface of OPC drum 90 is charged. The charged surface is then exposed under the control of microprocessor 88 to discharge the areas where it is not required to print an image. The surface then passes through toner trough 96, wherein liquid toner attaches to the charged areas of the surface in the desired image to be printed on the substrate. The surface bearing the toner then passes through reverse doctor roll 98 which removes any excess toner. Finally the surface bearing the toner rotates to transfer corona 92. Substrate 34 is fed from unwind spool 32 between OPC drum 90 and transfer corona 92, wherein the toner is transferred to substrate 34. Thus the image desired to be printed has been transferred to substrate 34.

Following transfer of the image, printed substrate 34 continues through a throughput nip formed by two rollers of fusing station 100. At least one of these rollers, usually the one that comes into direct contact with the printed image (the upper roller in the figure), is heated so as to cause fusing of the image onto substrate 34 so that it is permanently bonded to the substrate, thus preventing the image from being damaged. The printed substrate 34 then passes on to have the foil applied in the manner described with reference to FIG. 4.

FIG. 8 shows a printing apparatus of a second embodiment of the invention for performing hot dieless foiling. A substrate unwind spool 104 holds a supply of substrate 106 which is fed from the spool left to right in the figure, as indicated by arrows A. The ink-jet printing system of the embodiment of FIG. 4 is provided, comprising ink-jet head 36, adhesive supply 38, microprocessor 40 and computer 42. UV lamp 50 and its control system 52 are also present. Foil unwind spool 44, foil 10 and foil rewind spool 54 are used but between spools 44, 54 is provided a single throughput nip formed by heated roller 108 and impression roller 110. The foiled substrate is collected on foil rewind spool 112.

The substrate 106 may or may not be the same as that used in the cold dieless process of FIG. 4, hence the assigning of different reference numerals for it and its unwind and rewind spools. Heated roller 108 and impression roller 110 could be replaced with a heated platen and an impression bed.

In operation, substrate 106 is fed from substrate unwind spool 104 so that it passes underneath ink-jet head 36. Adhesive is applied in discrete patterns 37, as explained with reference to FIG. 4. However, the composition of the adhesive is different from that used in the cold dieless foiling system. Therefore, the next step is for the discrete patterns of adhesive 37 to pass under UV lamp 50, which irradiates them with UV light. This cures the adhesive on the substrate by initiating polymerisation of the monomer components of the adhesive. The irradiated substrate 106 then continues to rollers 108 and 110. It will be appreciated that due to the cured state of the adhesive, the direction of movement of the substrate 106 between UV lamp 50 and rollers 108, 110 could be changed by use of a turner bar, should this be desired.

Foil 10 is unwound from foil unwind spool 44 at the same line speed as substrate 106. Substrate 106 passes in overlap with foil 10 through the throughput nip formed bye rollers 108 and 110. Heat is transferred from heated roller 108 through foil 10 to the discrete patterns 37 of adhesive, thus rendering the adhesive tacky. Since the adhesive is in a tackified state and under pressure from the throughput nip, and the ability of the adhesive to adhere to complementary adhesive layer 15 is greater than the ability of the release layer 12 to hold layers 13, 14, 15 of the foil to carrier 11, an area of lacquer layer 13, metallic layer 14 and complementary adhesive layer 15 from foil 10 corresponding to each discrete pattern 37 of adhesive is removed from carrier layer 11 and sticks to the adhesive and is thus transferred onto the substrate 106.

The foiled substrate bearing the discrete areas of foil continues beyond rollers 108, 110 and is wound onto foiled substrate spool 112. The spent foil 10 is wound onto foil rewind spool 54 as before.

Thus it can be understood that, as in the first embodiment, namely the cold dieless foiling system of FIG. 4, the pattern of adhesive applied to substrate 106 by ink-jet head 36 determines the pattern in which foil is transferred to substrate 34. This brings similar advantages as those of the first embodiment in that there is no need for a fixed image plate such as a flexographic plate and therefore that the digital nature of the computer control of the ink-jet head allows the adhesive and hence the foil to be applied in a variety of patterns. Furthermore, the non-contact nature of the adhesive application procedure in this embodiment can allow printing on very delicate or highly flexible substrates.

FIG. 9 shows the system of FIG. 8 used with a digital printing system. The digital printing system is described with reference to FIG. 6. That description is not repeated here. Following printing with the digital printing system, the printed substrate 106 then passes on to have the foil applied in the manner described with reference to FIG. 8.

FIG. 10 shows the arrangement of FIG. 8 used together with a liquid toner digital printing system. The liquid toner digital printing system is described with reference to FIG. 7. That description is not repeated here. Following printing with the liquid toner digital system, the printed substrate 106 passes on to have the foil applied in the manner described with reference to FIG. 8.

It will be understood that the layout of any of the systems of FIGS. 4 to 10 can be varied, for example turner bars could be used to direct the substrate. It will also be appreciated that the arrangements of FIGS. 4 and 8 can be used with printing systems other than those shown in FIGS. 5-7 and 9-10.

FIG. 11 shows a printing apparatus of a third embodiment of the invention for performing cold dieless foiling. The components of FIG. 4 are used here but they are arranged differently.

Foil unwind spool 44 is located near to ink-jet head 36, so that foil 10 is fed underneath ink-jet head 36, via a turner bar 128. Ink-jet head 36 is controlled as before to dispense discrete adhesive patterns 37 onto foil 10. The components are arranged so that adhesive is printed onto complementary adhesive layer 15 of foil 10, not carrier layer 11. In an embodiment in which complementary adhesive layer 15 was not present, adhesive would be printed onto metallic layer 14.

The foil 10 bearing the adhesive is turned using a second turner bar 128 and is then turned again as it passes between nip rollers 46. Thus the adhesive is applied from above by ink-jet head 36 so that the discrete adhesive patterns 37 are facing upwards then the foil 10 is turned through substantially 180° so that the discrete adhesive patterns 37 are facing downwards as the foil 10 emerges from nip rollers 46. Substrate 34 is fed from substrate unwind spool 32 so that it passes through nip rollers 46 in overlap with foil 10 and in contact with discrete adhesive patterns 37.

After passing through nip rollers 46, the foil 10 and substrate 34 pass underneath UV lamp 50 and are irradiated with UV light as explained previously. Lamp 50 could alternatively be positioned underneath substrate 34 as discussed above. Upon passing through nip rollers 48, transfer of lacquer layer 13, metallic layer 14 and complementary adhesive layer 15 occurs as before.

FIG. 12 shows a printing apparatus of a fourth embodiment of the invention for performing hot dieless foiling. The arrangement uses the components of FIG. 8 but they are arranged in a similar way to those of FIG. 11. One difference between the arrangement of FIG. 11 and the arrangement of FIG. 12 lies in the position of UV lamp 50. Since this is a hot foiling system the adhesive is irradiated with UV light to cure it prior to transfer, hence the UV lamp 50 is located inbetween second turner bar 28 and nip rollers 46. Another difference between the arrangement of FIG. 11 and this arrangement is that nip rollers 48 are replaced by heated roller 108 and impression roller 110, so that the adhesive is activated to effect transfer, as described above with reference to FIG. 8. Nip rollers 46 could be omitted if this were convenient.

In FIGS. 11 and 12 the substrate is indicated as being the same as those of previous figures, but this does not have to be the case.

It will be understood that the arrangements of FIGS. 11 and 12 could be used in conjunction with the ink printing systems described with reference to FIGS. 5-7 and 9-10 or other similar systems. It will also be understood that in any of the examples mentioned the adhesive printing station may precede or follow the ink printing stations.

In some circumstances it may be desirable to accelerate the curing of the ink-jetted adhesive before the transferable layer of the foil is applied. This may help to stop the adhesive spreading as the transferable layer of the foil is applied to it, thus reducing the possibility of dot gain or smudging. It may also slightly tackify the adhesive, enabling it to adhere better to the transferable layer of the foil. One way to do this is to provide an additional UV lamp or other curing means to bear on the printed adhesive between the ink-jet printing head and the station where the foil is applied; for example between printing head 36 and rollers 46 in FIG. 5.

Means other than the rollers 46, 48, 108, 110 could be used to apply the foil against the substrate. Examples of other means include doctor blades and airknives.

Instead of a moveable ink-jet printing head 36, a fixed ink-jet head (preferably a multi-nozzle head) or a moveable or fixed continuous inkjet array could be used.

The station at which the foil is applied need not immediately follow the station at which the adhesive is applied. The stations could be entirely separate. Between the stations the substrate bearing the adhesive could, for instance, be rolled up and then unrolled, or cut into pieces and the pieces stacked and unstacked. One convenient way in which this could be implemented is by using an adhesive that can be activated or re-activated after having been cured. The adhesive is deposited on the substrate and cured, for example by being exposed to a UV lamp. The degree of curing could be partial but would need to be sufficient to render the adhesive non-tacky, which would generally mean over 50%. Then, once the adhesive is no longer tacky, the substrate can be handled, for example by being rolled up, and stored or transported to another location. Later the substrate can be heated to reactivate the adhesive and then run through the foiling station as described above. Alternatively, the substrate could be run through a conventional hot foiling station, in which the foil is pressed against the substrate by one or more heated rollers. This preferably discontinuous arrangement provides a number of additional advantages: the substrates can be stored before the transferable layer of the foil is deposited; and curing the adhesive before the foil is applied may give a more consistent result by making the system less dependent on the ink/substrate interaction.

FIG. 13 shows a fifth embodiment of the invention for performing cold dieless foiling. This embodiment uses the same components as the first embodiment shown in FIG. 4 but the components are arranged differently. Instead of the UV lamp 50 being placed above or below the foil 10 and the substrate 34 inbetween the pairs 46, 48 of nip rollers, the UV lamp is placed downstream of the pair 48 nip rollers. Thus the adhesive 38 is applied in discrete adhesive patterns 37 as before, and the foil 10 is applied in the manner previously described but before the adhesive 38 is cured. The adhesive 38 is however tacky when applied so that the foil 10 sticks to the areas of the substrate 34 on which the adhesive 38 has been applied. Subsequently to application of the foil 10, the foiled substrate passes underneath the UV lamp 50 and the adhesive 38 is thus cured so as to securely bond the foil 10 to the substrate 34.

Examples of suitable adhesives for use in this embodiment are the Sun Chemicals UFE 5554 pale blue free-radical ink or the transparent version thereof U3012. The transmission of UV light onto the foil 10 and through to the adhesive 38 creates free radicals in the adhesive 38 and in the foil 10 which react together to create a bond between the foil and the adhesive.

The fifth embodiment can be used in conjunction with any of the ink printing techniques shown in FIGS. 5 to 7, or with other ink printing techniques. The UV lamp 50 could alternatively be placed beneath the substrate 34.

FIG. 14 shows a sixth embodiment of the invention for performing hot dieless foiling. This embodiment uses the same components as the second embodiment shown in FIG. 8 but the components are arranged differently. Instead of the UV lamp 50 being placed above or below the foil 10 and the substrate 34 before the throughput nip formed by the heated roller 108 and the impression roller 110, the UV lamp is placed downstream of the rollers 108, 110. Thus the adhesive 38 is applied in discrete adhesive patterns 37 as before, and the foil 10 is applied in the manner previously described but before the adhesive 38 is cured. The adhesive 38 is however tacky when applied so that the foil 10 sticks to the areas of the substrate 34 on which the adhesive 38 has been applied. Subsequently to application of the foil 10, the foiled substrate passes underneath the UV lamp 50 and the adhesive 38 is thus cured so as to securely bond the foil 10 to the substrate 34.

An example of a suitable adhesive for use in this embodiment is the Sun Chemicals UPA 7559 free-radical ink. The transmission of UV light onto the foil 10 and through to the adhesive 38 creates free radicals in the adhesive 38 and in the foil 10 which react together to create a bond between the foil and the adhesive.

The sixth embodiment can be used in conjunction with either of the ink printing techniques shown in FIGS. 9 and 10, or with other ink printing techniques. The UV lamp 50 could alternatively be placed beneath the substrate 34.

An advantage of the fifth and sixth embodiments is that the nature of the adhesive is such that curing after foiling can be done to such an extent as to cure the adhesive to a solid, thus creating a more permanent bond between the foil and the substrate 34.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A method for the application of a transferable layer from a foil to a substrate, the method comprising the steps of:
(i) applying an adhesive in a pattern to one of the substrate and the foil using a drop on demand deposition head;
(ii) curing the adhesive; and
(iii) transferring the transferable layer in the pattern from the foil to the substrate.

2. A method according to claim 1, wherein steps (ii) and (iii) are conducted substantially simultaneously on the same regions of the foil and the substrate.

3. A method according to claim 1, wherein step (iii) is effected by passing the substrate and foil through a throughput nip which effects the transfer of the transferable layer from the foil to the substrate.

4. A method according to claim 1, comprising the further step of:
(iv) heating the one of the substrate and the foil bearing the cured adhesive to render the adhesive tacky.

5. A method according to claim 4, wherein steps (iii) and (iv) are conducted substantially simultaneously on the same regions of the foil and the substrate.

6. A method according to claim 5, wherein step (iv) is effected by passing the substrate and foil through a heated throughput nip which effects heating of the adhesive to render the adhesive tacky and which effects the transfer of the transferable layer from the foil to the substrate.

7. A method according to claim 6, wherein the heated throughput nip comprises a heated roller and an impression roller.

8. A method according to claim 7, wherein the foil and substrate are fed at the same line speed through the heated throughput nip with the foil layer to the side of the heated roller and the substrate to the side of the impression roller.

9. A method according to claim 6, wherein the heated throughput nip comprises a heated platen and an impression bed.

10. A method according to claim 4, wherein the adhesive composition is such that, subsequent to curing of the adhesive, the adhesive can be rendered tacky by the application of heat to enable the subsequent transferring and adhering of the transferable layer from the foil to the substrate.

11. A method according to claim 1, wherein the drop on demand deposition head is controlled to apply the adhesive in the pattern.

12. A method according to claim 1, wherein in step (ii) the adhesive is cured to the extent that the cured adhesive is not transferred to any parts of an apparatus upon which the process is conducted that impinge on the pathway of the substrate between the curing step and the transfer step.

13. A method according to claim 1, wherein the curing step is effected by irradiation with ultra-violet light.

14. A method according to claim 13, wherein the foil is at least partially UV transparent and the ultra-violet light is irradiated through the foil onto the adhesive.

15. A method according to claim 13, wherein the substrate is at least partially UV transparent and the ultra-violet light is irradiated onto the adhesive through the substrate.

16. A method according to claim 1, wherein the pathway of the substrate is such that, subsequent to the curing step, and prior to the transferring step, the substrate is passed around a redirecting means that directs the pathway of the substrate towards a station in which the transferring step takes place.

17. A method according to claim 1, further comprising the step of applying one or more ink layers to the substrate prior to or after the application of the adhesive.

18. A method according to claim 1, wherein the method is continuous.

19. A method according to claim 18, wherein the drop on demand deposition head is controllable to print different patterns.

20. A method according to claim 1, wherein the foil comprises a carrier layer, a release layer, and a transferable layer and the transferable layer is transferred to the substrate by virtue of the ability of the applied adhesive to adhere to it being greater than the ability of the release layer to hold it to the carrier layer during step (iii).

21. A method according to claim 1, wherein the drop on demand deposition head is an ink-jet head.

22. A method according to claim 1, wherein the transferable layer is a pigmented, metallic or holographic layer or more than one thereof.

23. A method according to claim 1, comprising the step, between the said curing step and the said transferring step, of storing the substrate.

24. A method according to claim 1, comprising the steps, between the said curing step and the said transferring step, of rolling the substrate into a roll, and unrolling the substrate.

25. A method according to claim 1, comprising the step, between the said curing step and the said transferring step, of heating the adhesive to activate it.

26. (canceled)

27. An apparatus for the application of a transferable layer from a foil to a substrate, the apparatus comprising:
(i) a drop on demand deposition head for applying an adhesive to one of the substrate and the foil in a pattern;
(ii) means for curing the adhesive; and
(iii) means for transferring the transferable layer in the pattern from the foil to the substrate.

28. An apparatus according to claim 27 wherein (ii) and (iii) are arranged to operate substantially simultaneously on the same regions of the foil and the substrate.

29. An apparatus according to claim 27, further comprising a throughput nip through which the substrate and foil can be passed to effect the transfer of the transferable layer from the foil to the substrate.

30. An apparatus according to claim 27, further comprising:
(iv) means for heating the substrate bearing the cured adhesive to render the adhesive tacky.

31. An apparatus according to claim 30 wherein (iii) and (iv) are arranged to operate substantially simultaneously on the same regions of the foil and the substrate.

32. An apparatus according to claim 30, wherein the heating means and the transferring means comprise a heated throughput nip through which the substrate and foil can be passed to effect heating of the adhesive to render the adhesive tacky and to effect the transfer of the transferable layer from the foil to the substrate.

33. An apparatus according to claim 32, wherein the heated throughput nip comprises a heated roller and an impression roller.

34. An apparatus according to claim 33, arranged to feed the foil and substrate at the same line speed through the heated throughput nip with the foil layer to the side of the heated roller and the substrate to the side of the impression roller.

35. An apparatus according to claim 32, wherein the heated throughput nip comprises a heated platen and an impression bed.

36. An apparatus according to claim 30, wherein the adhesive composition is such that, subsequent to curing of the adhesive, the adhesive can be rendered tacky by the application of heat to enable the subsequent transferring and adhering of the transferable layer from the foil to the substrate.

37. An apparatus according to claim 27, further comprising a controller for controlling the drop on demand deposition head to apply the adhesive in the pattern.

38. An apparatus according to claim 27, wherein the curing means is arranged to cure the adhesive to the extent that the cured adhesive is not transferred to any parts of an apparatus upon which the process is conducted that impinge on the pathway of the substrate between the curing step and the transfer step.

39. An apparatus according to claim 27, wherein the means for curing the adhesive comprises an ultra-violet light source.

40. An apparatus according to claim 39, wherein the foil is at least partially UV transparent and the ultra-violet light source is disposed to irradiate ultra-violet light through the foil onto the adhesive.

41. An apparatus according to claim 39, wherein the substrate is at least partially UV transparent and the ultra-violet light source is disposed to irradiate ultra-violet light onto the adhesive through the substrate.

42. An apparatus according to claim 27, further comprising redirecting means positioned between the curing means and the heating means that directs the pathway of the substrate towards the heating means.

43. An apparatus according to claim 42, wherein the redirecting means comprises a turner bar.

44. An apparatus according to claim 27, further comprising means for applying one or more ink layers to the substrate.

45. An apparatus according to claim 27 which is continuous.

46. An apparatus according to claim 45, wherein the controller controls the drop on demand deposition head to print different patterns.

47. An apparatus according to claim 27, wherein the foil comprises a carrier layer, a release layer, and a transfer layer and the transfer layer is transferred to the substrate by virtue of the ability of the applied adhesive to adhere to it being greater than the ability of the release layer to hold it to the carrier layer during step (iii).

48. An apparatus according to claim 27, wherein the drop on demand deposition head is an ink-jet head.

49. An apparatus according to claim 27, wherein the transferable layer is a pigmented, metallic or holographic layer or more than one thereof.

50. (canceled)

51. A method for the application of a transfer layer from a foil to a substrate, the method comprising the steps of:
(i) applying an adhesive to one of the substrate and the foil;
(ii) curing the adhesive by exposing it to a curing means through the one of the substrate and the foil; and
(iii) transferring the transfer layer from the foil to the substrate.

52. A method according to claim 51, wherein the one of the substrate and the foil is at least partially UV transparent and step (ii) is carried out by irradiating ultra-violet light onto the adhesive through the one of the substrate and the foil.

53. A method according to claim 51, wherein the transferable layer is a pigmented, metallic or holographic layer or more than one thereof.

54. An apparatus for the application of a transfer layer from a foil to a substrate, the apparatus comprising:
(i) means for applying an adhesive to one of the substrate and the foil;
(ii) means for curing the adhesive arranged such that the adhesive is exposed thereto through the one of the substrate and the foil; and
(iii) means for transferring the transfer layer from the foil to the substrate.

55. An apparatus according to claim 54, wherein the one of the substrate and the foil is at least partially UV transparent and (ii) is an ultra-violet light source disposed to irradiate ultra-violet light onto the adhesive through the one of the substrate and the foil.

56. An apparatus according to claim 54, wherein the transferable layer is a pigmented, metallic or holographic layer or more than one thereof.
